(19) United States
(12) Patent Application Publication
(10) Pub. No.: US 2011/0157140 A1
(43) Pub. Date: Jun. 30, 2011

(54) VOLTAGE CONTROL ON N-WELLS IN MULTI-VOLTAGE ENVIRONMENTS

(75) Inventors: DOUGLAS PIASECKI, AUSTIN, TX (US); THOMAS S. DAVID, AUSTIN, TX (US); TIMOTHY THOMAS RUEGER, AUSTIN, TX (US); STEFAN MASTOVICH, AUSTIN, TX (US); JIA-HAU LIU, AUSTIN, TX (US)

(73) Assignee: SILICON LABORATORIES INC., AUSTIN, TX (US)

(21) Appl. No.: 12/651,311

(22) Filed: Dec. 31, 2009

(51) Int. Cl. G09G 5/00

(52) U.S. Cl. 345/212

(57) ABSTRACT

An output pad control logic comprises an output buffer including a plurality of transistors connected to drive signals for an output pad. Each of the plurality of transistors includes an n-well. An n-well generator connects a first voltage to the n-wells of the plurality of transistors of the output buffer in a first mode of operation when a system rail voltage exceeds a pad voltage applied to the output pad. The n-well generator connects the pad voltage to the n-wells of the plurality of transistors of the output buffer in a second mode of operation when the pad voltage applied to the output buffer exceeds the system rail voltage. A switching circuit is responsive to at least one control signal to connect the system rail voltage as the first voltage when the output pad is not driving an LCD display and to connect a larger of the system rail voltage and an LCD drive voltage as the first voltage when the output pad is driving the LCD display.

### CROSS-REFERENCE TO RELATED APPLICATIONS

This application is related to U.S. patent application Ser. No. 12/495,564, filed on Jun. 30, 2009, entitled SYSTEM AND METHOD FOR LCD LOOP CONTROL (Atty. Dkt. No. CYGL-29,506), U.S. patent application Ser. No. 12/495,576, filed Jun. 30, 2009, entitled LCD CONTROLLER WITH BYPASS MODE (Atty. Dkt. No. CYGL-29,507), and U.S. patent application Ser. No. 12/495,600, filed on Jun. 30, 2009, entitled LCD CONTROLLER WITH OSCILLATOR PREBIAS CONTROL (Atty. Dkt. No. CYGL-29,508), all of which are incorporated herein by reference in their entirety.

### TECHNICAL FIELD

The present invention relates to voltage control for n-wells, and more particularly, to providing voltage controls for n-wells in a multi-voltage environment.

### BACKGROUND

Within MOSFET transistors, there exists the need to bias the n-wells in order to meet certain operating characteristics within a particular system design. In most systems, utilizing a single n-well voltage is sufficient because only a single system rail voltage is utilized. However, in some operating environments, there are multiple system voltages that are being utilized based on differing system operating requirements. For example, a first group of digital components within a particular system may operate in a 1.7 volt to 1.8 volt voltage range. A second group of digital components within the same system may operate within the 1.8 volt to 3.6 volt voltage range. Finally, within analog components of the same system, a need may exist to operate over the entire 1.7 volt to 3.6 volt range encompassed by each of the different types of digital components.

When transmitting signals from and receiving signals at the inputs and outputs of the varying components having different voltage requirements, there is often the need to translate the voltages to a level that can be accepted by the inputs and outputs of the receiving system. Thus, there may arise a situation wherein the voltages on the inputs or outputs of a particular device may exceed the system voltage that is being applied to the particular group of components. When this occurs, operating errors and other types of system inefficiencies such as current losses and potential damage to components may arise. In order to protect against these type of system problems, it would be desirable to have the ability to alter the biasing voltages which may be applied to various transistors within the system, and in particular, to the n-wells associated with these transistors.

### SUMMARY

The present invention, as disclosed and described herein, in one aspect thereof, comprises output pad control logic. The logic includes an output buffer including a plurality of transistors connected to drive signals for an output pad. Each of the plurality of transistors includes an n-well. An n-well generator connects a first voltage to the n-wells of the plurality of transistors of the output buffer in a first mode of operation when the system rail voltage exceeds a pad voltage applied to the output pad. The n-well generator connects the pad voltage to the n-wells of the plurality of transistors of the output buffer in a second mode of operation when the pad voltage applied to the output pad exceeds the system rail voltage. Switching circuitry is responsive to at least one control signal for connecting the system rail voltage as the first voltage when the output pad is not driving an LCD display and connects a larger of the system rail voltage in the LCD drive voltage as the first voltage when the output pad is driving the LCD display.

### BRIEF DESCRIPTION OF THE DRAWINGS

For a more complete understanding, reference is now made to the following description taken in conjunction with the accompanying Drawings in which:

FIG. 1 is a block diagram of an LCD controller operating in a multi-voltage environment;

FIG. 2 is a block diagram of the control circuitry for the LCD/GPIO pins of the LCD controller;

FIG. 3 is a functional block diagram of the LCD controller block;

FIG. 4 provides a more detailed illustration of the circuitry of the LCD controller block;

FIG. 5 is an upper level block diagram of the pad control logic for the LCD controller;

FIG. 6 is a schematic diagram illustrating a prior art configuration of the pad circuitry;

FIG. 7 illustrates the current through the output pad responsive to the pad voltage increasing above the rail voltage;

FIG. 8 is a schematic diagram illustrating the improved pad logic for altering the voltage applied to the n-well transistors associated with the pad logic;

FIG. 9 illustrates the pad logic multiplexer for applying the differing voltages to the n-wells of the pad logic transistors;

FIG. 10 is a schematic block diagram of the n-well control circuit for selecting the system voltage to be applied to the n-wells of the transistors; and

FIG. 11 is a logic diagram illustrating the n-well control circuit of FIG. 10.

### DETAILED DESCRIPTION

Referring now to the drawings, wherein like reference numbers are used herein to designate like elements throughout, the various views and embodiments of a voltage control on n-wells in multi-voltage environments are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

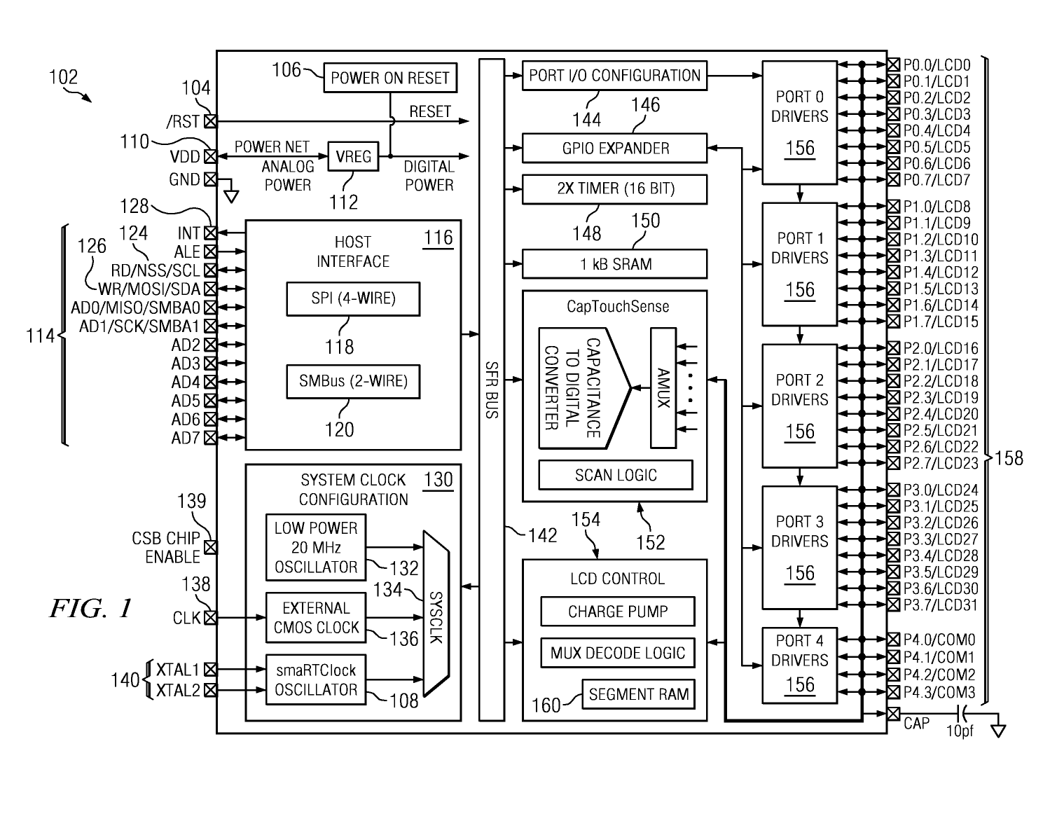

Referring now to FIG. 1, there is illustrated a block diagram of an LCD controller 102. The LCD controller 102 has two main reset sources. These include the RST PIN 104 and the power on reset block 106. The power on reset signal is generated by the power on reset block 106 tied to the V_{DD} pin 110 when the LDO (low dropout regulator) voltage regulator 112 turns on. In low power mode, when the LDO voltage regulator 112 is enabled, a power on reset signal is generated which will reset all of the logic except for the real time clock 108 and the LCD power control block (not shown). These blocks can only be reset via the RST PIN 104 when the LCD low power enable bit is turned off. After this, the real time clock 108 can be reset via either source, although the LCD low power block can still only be reset via the RST PIN 104. System power is provided via a V_{DD} pin 110 to a LDO voltage regulator 112. The system power applied to V_{DD} pin 110 is used to provide external power to the system through an associated power net, and the voltage regulator 112 provides regulated voltage to provide regulated power throughout the LCD controller 102. The power at V_{DD} pin 110 is the raw unregulated power that is used to power the analog circuitry and provide power in low power mode. Basically, this is considered to be V_{BAT} for the battery voltage. Note that the regulated power can be disabled in low power mode.

The LCD controller 102 is a slave to an external MCU through a plurality of interface pins 114 connected with the host interface 116. The host interface 116 supports a four wire SPI (serial port interface) 118 and a two wire SMBus interface 120, all in a slave mode of operation only. The bus type supported by the host interface 116 is selected via the RST PIN 104. A default mode for the LCD controller 102 is the SPI mode, providing for a serial data communication mode of operation. If, while the part is in reset, the RD pin 124 is held high or low while the WR pin 126 is held low, the controller 102 will power up in the SPI mode controlled by SPI 118. Finally, if while the LCD controller 102 is held in reset, the WR pin 126 is held high while the RD pin 124 is held low, the controller 102 will power up in the SMbus mode controlled by the SMBus interface 120.

The INT (interrupt) pin 128 is used to indicate the interface mode upon leaving reset mode. Upon exiting the reset mode, the INT pin 128 will toggle with the frequency of the system clock divided by eight to indicate that the SPI mode has been selected, and the interrupt pin 128 will be toggled with the frequency of the system clock divided by thirty-two to indicate the SMBus mode selection. This toggling will go on for two hundred fifty six system clock cycles, after which the INT pin 128 will revert to functioning as the interrupt pin.

As noted herein above, each of the LCD controllers 102 is addressable. By enabling the particular chip, the data and address information can be sent thereto such that data can be written to a specifically addressed SFR (Special Function Register) or read therefrom. As noted herein above, each LCD controller 102 is substantially identical such that the address space for each SFR is the same for each LCD controller 102. As such, there must be some way to distinguish between LCD controllers 102. With respect to the serial data bus protocols, the chip enable pin is not required, as each of these two protocols has the ability to address a specific chip. Again, this is part of the protocol. Thus, all that is required to address a particular chip and write data thereto or read data therefrom is a communication path and a particular data communication protocol and an appropriate way to select a particular chip. Further, each of these chips will have a separate interrupt pin that will allow an interrupt to be sent back to the MCU that controls the controller 102. There will, of course, have to be provided one interrupt line for each LCD controller 102 such that the particular LCD controller generating the interrupt can be distinguished. What will happen then is that the MCU will take the appropriate action, which will typically require the chip to be enabled and, after enabling, download the appropriate configuration information thereto, this assuming that the LCD controller 102 which generated the interrupt was in the low power mode of operation.

The system clock configuration block 130 enables the provision of a system clock signal from up to six clock sources. The low power 10 MHz oscillator 132 may provide a 10 MHz clock signal or alternatively may be divided by 2, 4 or 8 to provide a divided down 10 MHz clock signal to a multiplexer 134 for selection as the system clock. Additionally, external CMOS clock circuitry 136 may be used to provide the clock signal to the multiplexer 134 responsive to an external clock received via a clock pin 138. Finally, a real time clock oscillator (RTC) 108 may be used to provide a system clock signal to the multiplexer 134 for use in a power down mode of operation. The real time clock is configured via a pair of external pins 140.

The LCD controller 102 boots up running the 10 MHz oscillator 132 in a divide by 4 mode. The LCD controller 102 may then be configured to any of the other clock sources. The internal oscillator can be controlled, i.e., turned on and off, either using an internal control register while running off the CMOS clock or by using an external control mode while toggling a pin (in this case the CMOS_clock pin 138) to turn the internal oscillator on and off. The system clock configuration block 130 and associated clock circuitry therein are described in co-pending U.S. patent application Ser. No. 11/967,389 entitled “POWER SUPPLY VOLTAGE MONITORS” which is incorporated herein by reference in its entirety. The system clock configuration 130 with the control register includes a control register bit which may be used to enable a sleep mode of the system clock. When this register bit is set, the clock pin 138 may be used to enable and disable the internal low power oscillator 132 without removing power from the remainder of the controller circuitry. This would comprise a sleep mode wherein the circuitry of the controller 102 remains under system power, i.e., connected to V_{BAT} or V_{EXT} on the V_{DD} pin, but no clock signal is provided from the oscillator 132. The real time clock oscillator 108 is unable to be trimmed. The real time clock oscillator 108 requires a 32 KHz oscillator and runs on the V_{BAT} voltage, external power. The RTC 108 provides the LCD clock source for the LCD controller 102 both in high and low power modes since it is powered from external power and will not lose power when the LDO voltage regulator 112 is powered down. The RTC 108 may be reset by the RST PIN 104 only when in low power mode. When in high power mode, the RTC 108 may be reset by either the reset pin 104 or the power on reset 106 connected to the V_{DD} pin.

The CSB chip enable pin 139 enables the controller 102 to be operated in two different modes. When a particular bit within an associated SFR register is set, the CSB chip enable pin 139 may be used to enable and disable the LDO voltage regulator 112 within the controller 102 without removing power to the rest of the circuitry running on V_{BAT} within the controller 102. In this mode of operation, a bit is set internally that will designate the chip select bit as being an enable/disable pin for the LDO 112. In this mode of operation, the MCU can generate through a dedicated line to a particular LCD controller 102 a signal that will cause the system to go into a low power mode. In this mode, what will happen is that the LDO 112 will be powered down. This will result in the loss of power to a large block of circuitry, including registers and such. However, there will be a certain portion of the circuitry, such as certain portions of the LCD drivers or capacitive scanning circuitry, that will be enabled. The RTC 108 will also remain powered since it is not driven from the output of the LDO voltage regulator 112. In this mode of operation there will be certain registers that draw little power, but can be powered from the external power which is not regulated and may vary quite a bit. This particular circuitry, of course, is fabricated from high voltage circuitry whereas the circuitry associated with the output of the LDO voltage regulator 112 can have a regulated voltage and can be fabricated from much lower power (lower voltage) circuitry with thinner oxides and the such. When the system is re-enabled, what will happen is the LDO 112 will be powered up and then a power on reset generated. In this power on reset, what will happen is that certain registers will be cleared, as they may have an unknown state, and then the configuration information is downloaded from the MCU 104 over the communication bus 110 to the LCD controller 102. The reason that this is required is because no flash memory is contained on-chip within the LCD controller 102. If memory were provided, this would not be necessary. However, that results in a much more expensive part and a different fabrication process. Since the MCU has flash memory, it is only necessary to download the information thereto. As noted herein above, one event that can cause the MCU to re-enable the LCD controller 102 is the generation of an interrupt by the part. This interrupt indicates the presence of a touch on the capacitive sense array or the change of a value on a GPIO pin or any other pin with the port match feature. The re-enable is necessary in order to service the interrupt. However, during operation where the system is waiting for some change in the capacitive sense array or waiting for some change in data on a port, the part is placed in a low power mode of operation.

Components within the LCD controller 102 communicate via an SFR bus 142. The SFR bus 142 enables connections with a number of components including port I/O configuration circuitry 144, GPIO expander 146, timers 148, SRAM 150, capacitive touch sense circuitry 152 and the LCD control block 154. The port I/O configuration circuit 144 enables control of the port drivers 156 controlling a plurality of general purpose input/output (GPIO) pins 158 to configure the ports as digital I/O ports or analog ports. These GPIO pins 158 may be connected to a liquid crystal display controlled via the LCD control block 154, or alternatively, could be connected to a capacitive sensing array controlled via the capacitive touch sense circuitry 152. Further, they could be configured to be a digital input or output to allow the MCU 104 to expand its own internal GPIO capabilities.

The GPIO expander 146 offers a connection to 36 GPIO pins 158 for general purpose usage. The GPIO expander 146 allows the MCU, which itself has a plurality of pins which can be dedicated to digital input/output functions, to expand the number of pins available thereto. By addressing a particular LCD controller 102 and downloading information thereto while that LCD controller 102 is configured as a GPIO expander, data can be written to or read from any set of the GPIO pins on that LCD controller 102. This basically connects those pins through the port drivers to the SFR bus of the MCU 104.

The GPIO pins 158 can also be used for port match purposes. In the port match mode, each port can be treated as a match target with individual match selects for each pin. The port match process is a process wherein an internal register has a bit associated with a particular input/output pad. This pad will have associated therewith a digital I/O circuit which allows data to be received from an external pin or transmitted to an external pin. When configured as a digital I/O pin, this feature is enabled. However, each pin can also be configured to receive analog data or transmit analog data such that it is an analog pin. When so configured, the digital I/O circuitry is disabled or “tri-stated.” The port match feature has digital comparator circuitry external to the pad provided which basically compares the current state of the associated pin with a known bit, this being a bit that is on the pin at the time of setting. Changing of the data indicates a change in the state which will generate an interrupt and will load information in a particular register such that this internal register or SFR can be downloaded and scanned to determine which port incurred a change. Of course, the MCU also can just read the port pin itself. What this allows is one pin to be “toggled” to allow a signal to be sent external to the chip (LCD controller 102) to the MCU indicating that new data has arrived. This is a way of clocking data through.

If an ultra low power port match mechanism is desired, the LCD controller 102 can be switched into ultra low power mode and the same register used to save port match values. In this mode, the port match is forced to either match on all negative going signals or all positive going signals based on a bit in a configuration register. A port match will cause the generation of an interrupt via interrupt pin 128 which will cause the master controller MCU to have to turn on the LDO voltage regulator 112 by pulling the CSB chip enable pin 139 low and, after detecting an interrupt, begin communicating with the LCD controller 102.

The timers 148 comprise generic 16-bit timers. Upon overflowing, the timers 148 will generate an interrupt via interrupt pin 128 to the master controller. The timer circuit 148 comprises two 16-bit general purpose timers. One timer is normally used for the SMBus time-out detection within the controller 102. The other timer is used as the capacitive sense time-out timer for the capacitive touch sense circuitry 152. The 1 kB SRAM 150 is offered for general purpose usage and can be read from and written to via any of the three host interfaces 116. The SRAM 150 can be unpowered if desired via a configuration bit. Thus, in applications that do not require extra SRAM, power can be saved by powering down the SRAM. Note that this SRAM 150 will lose its contents when the LDO is shut off.

The capacitive touch circuitry 152 implements a capacitive touch sense capability up to a maximum of 128 possible sensing locations. This large number of touch sense pins is supported via an array sensing capability. The capacitive touch sense circuitry 152 includes three operating modes: the linear auto scan mode, the row/column auto scan mode and the 4×4 scan with LCD mode. Each capacitive pin detection takes approximately 32 microseconds. Thus, sensing 128 possible touch sense locations will take approximately 4.6 milliseconds which is well within any human interface appliance timing requirements. As noted herein above, whenever the system is configured for scanning, the system can operate in a low power mode or in a high power mode. In a low power mode, the system basically waits for some indication that a particular pad has been touched and then generates an interrupt. As will be described herein below, this basically utilizes the analog aspect of each of the pads, i.e., the analog value on each of the pads is sensed.

The LCD control block 154 of the LCD controller 102 can operate in static, 2×, 3× or 4× multiplexed modes. The LCD control block 154 can drive a maximum of 128 LCD segments in 4× multiplex mode or 96 segments in 3× multiplex mode and 64 segments in 2× multiplex mode. In static mode, the LCD control block 154 will drive 32 segments. The LCD control block 154 also supports a blinking mode where individual segments can be blinked on and off. The LCD control block 154 also supports a contrast selection setting capability supporting 16 different contrast levels. A maximum of 32 LCD segment pins and four common mode pins are defined.

The LCD control block 154 also supports an ultra low power (ULP) static mode capability wherein the controller 102 will keep an LCD display illuminated while driven off the V_{BAT} supply and not use the charge pump or low dropout regulator. This is done by driving the LCD pad outputs directly via toggling the set and reset pins on the pad level shifters based on the data in a segment RAM 160. In the ultra low power mode of operation, the LCD controller 102 may be operated in static LCD mode to keep an LCD perpetually illuminated with repeating data. The data to be displayed on the LCD is written to four data registers independent of the normal LCD data registers. The rest of the part is shut down, leaving the RTC and LCD running entirely off the V_{BAT} supply. If it is deemed necessary to change the data in the LCD data registers, the CSB chip enable pin 139 will have to be pulled low which will enable the LDO voltage regulator 112 and generate a power on reset to the chip after which communication can begin with the master and the LCD controller 102. Note that the bus type selection is latched in the logic running off the V_{BAT} domain. Thus, when returning from the ULP mode, it is not necessary to go through bus selection signaling again. The reset pin, if toggled at this time, will reset the LCD as well as the rest of the chip, thus requiring bus selection signaling once again. Note that since this mode toggles, the digital outputs of the pads in this mode could also be used to generate any sort of low speed digital wave form on any of the GPIO pins 158.

In operation, the multiplexers associated with the analog voltage multiplexer 308 and the output control signals are actually provided in the I/O pad. In the I/O pad, there is provided a multiplexer which has four inputs associated therewith and a single output connected to the pin when the pin is configured for the analog mode at that port. Each of the multiplexers associated with each of the pads has a control signal associated therewith. This control signal is comprised of four lines, one for selecting each of the voltages in the multiplexer. Therefore, there will be a common four-line bus that will route the four lines for the four voltages to each of the multiplexers for each of the pads. There will then be four control lines dedicated to each multiplexer such that, for 38 pins, there will be 38×4 control lines that will control the multiplexers such that each multiplexer is individually controllable. Therefore, the multiplexing operation is transferred to the pads as opposed to being in a central circuit.

In ULP port match mode the part can be shut down completely, except for the RTC and LCD_LP blocks, except that when a port match is detected the interrupt pin is toggled, thus waking up the host controller which can then resume communications with the LCD controller based upon the preserved bus type selection. Note that the port match function in the higher power mode allows skipping of these steps since the machine states will be preserved unlike the ULP port match function.

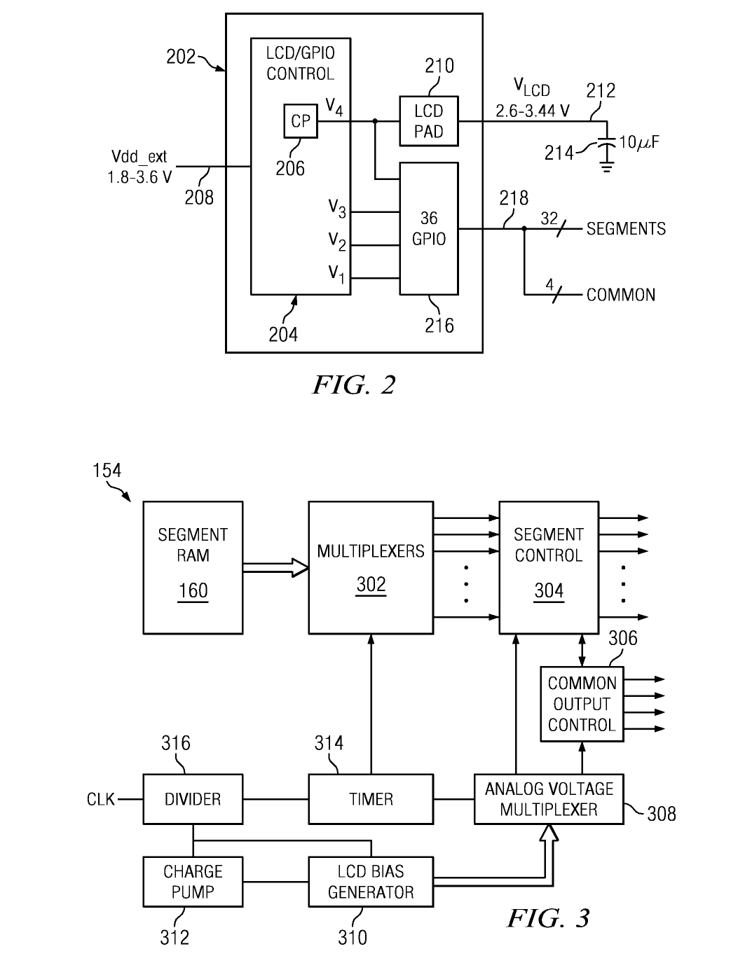

Referring now to FIG. 2, there is illustrated a generalized block diagram of the control circuitry for the LCD/GPIO output pins of the LCD controller 202. The LCD controller includes an LCD/GPIO control block 204 which provides four different output voltages V1, V2, V3 and V4. The voltages V1 through V3 are provided from the LCD/GPIO control block 204. The voltage V4 is provided from a charge pump block 206 within the LCD/GPIO control block 204. Each of these voltages V1 through V4 are provided responsive to a provided external voltage VDD_EXT (corresponding to V_{DD} or V_{BAT} in FIG. 1) which may be between 1.8 volts and 3.6 volts. The external voltage is provided to the LCD/GPIO control block 204 via an external pin 208. The voltage V4 is provided from the LCD pad 210 associated with an LCD pin 212. The LCD pin 212 provides a voltage to an associated LCD represented by the capacitor 214. Each of the voltages V1 through V4 are also provided to the GPIO pad logic 216 associated with the 36 GPIO pins 218. The GPIO pins 218 are connected to provide 32 segment control signals to associated LCDs and four common control signals in order to provide the controls to the connected LCDs in both static and multiplexed modes of operation.

Referring now to FIG. 3, there is provided a functional block diagram of the LCD control block 154. The LCD control block 154 contains the components necessary for driving various segments of an attached liquid crystal display that is attached to the various I/O pins 158 (FIG. 1). Segment RAM 160 includes the information necessary for controlling segments within attached liquid crystal displays to display information in a desired manner. The segment RAM 160 includes storage locations each associated with a particular LCD segment. In order to turn on an LCD segment, a memory bit within the segment RAM 160 is set.

The multiplexers 302 enable the LCD controller 102 to operate in either the static, 2×, 3×, or 4× multiplexed modes. The segment control block 304 provides the LCD controller with the ability to drive a maximum of 128 LCD segments in the 4× multiplexed mode, 96 LCD segments in the 3× multiplexed mode, and 64 LCD segments in the 2× multiplexed mode. Within the static mode, the segment control block 304 may control 32 LCD segments. The common output control block 306 provides four common mode pin outputs for providing control during 2×, 3× and 4× multiplexed modes.

The analog voltage multiplexer 308 provides the various voltages to the segment control block 304 and the common output control block 306 necessary for providing the voltages to activate or deactivate particular LCD segments. The bias voltages used by the analog voltage multiplexer 308 for driving the various crystal segments are generated within the LCD bias generator 310. A charge pump 312 provides the necessary voltages to the LCD bias generator 310 for generating the segment driving voltages. Timer circuitry 314 controls the timing of the LCD control block 154. Finally, a divider circuit 316 may be used to generate various clock signals for controlling the operation of the timer circuitry 314 and the operation of the charge pump 312 and LCD bias generator 310 responsive to an externally provided clock. The blocks 304-312 are generally included in FIG. 2.

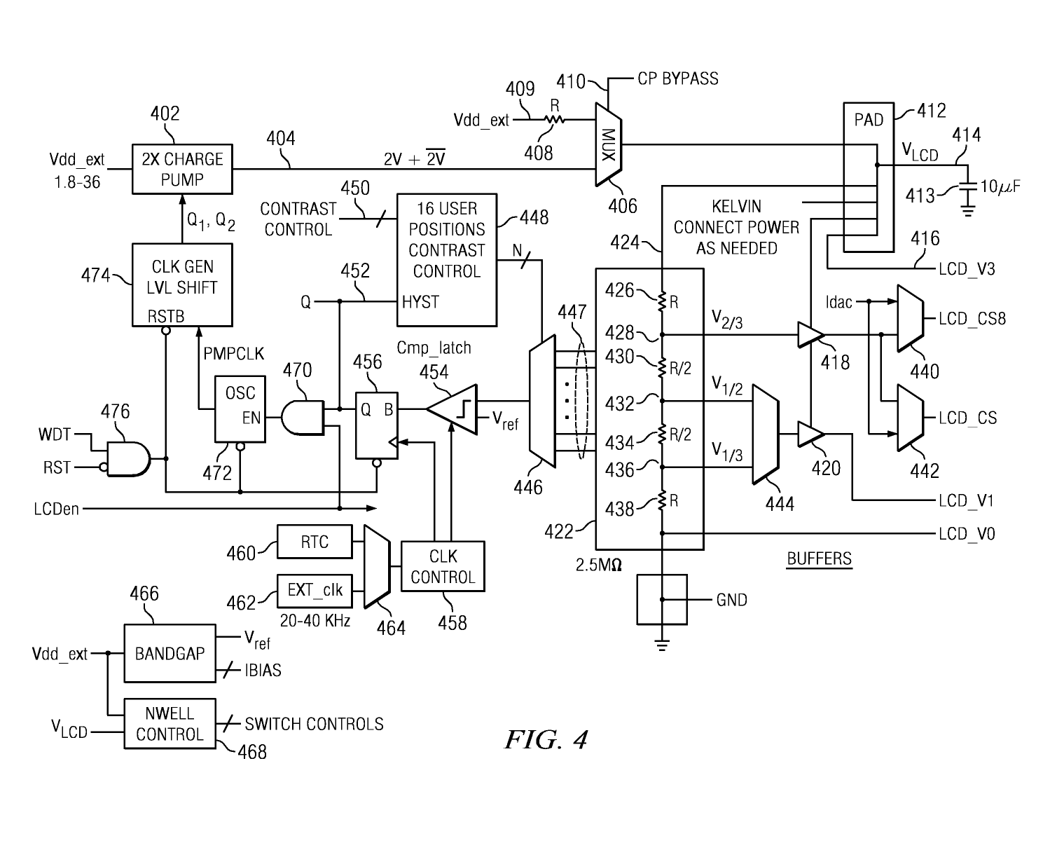

Referring now to FIG. 4, there is provided a more detailed illustration of the LCD controller circuitry. The external voltage VDD_EXT consisting of a 1.8 volt-3.6 volt signal is input to a 2× charge pump 402. The 2× charge pump 402 responsive to the provided external voltage generates up to twice the provided input voltage and outputs the voltage on line 404 to a multiplexer 406. The multiplexer 406 receives the voltage from the 2× charge pump 402 and can also receive an external voltage VDD_EXT through a resistor 408. The multiplexer, in one mode of operation, selects between the VDD_EXT signal and the voltage signal from the 2× charge pump 402 responsive to a CP bypass signal provided via control input 410 from an associated MCU. The CP bypass signal selects the voltage applied to the pad 412 based upon the selection mode by the MCU. The pad 412 provides the voltage from the multiplexer 406 as the voltage VLCD which is output via pin 414, pin 414 having an external capacitor 413 disposed thereon to ground. The voltage VLCD from the multiplexer 406 is also provided as an LCD drive voltage LCD_V3 at node 416 and as an input signal to a pair of buffers 418 and 420.

Using the multiplexer 406, a bypass mode of operation may be implemented using a bypass control provided on control input 410. In the bypass mode of operation, an external voltage VDD_EXT is provided directly to the output pad 412 through resistor 408 and a switch 409. In the bypass mode of operation this provides the voltage for the output pad from the input through resistor 408 rather than utilizing the charge pump 402 and associated circuitry within the control loop. By controlling the switching frequency of the switch 409 the voltage provided to the output pad LCD drive logic may be altered. Use of a larger switching frequency will increase the apparent voltage applied at the output pad logic for a given load condition. The switching frequency effectively changes the apparent load of the resistor 408 into VDD_EXT Similarly, a lower switching frequency will lower the provided voltage. This separate manner of control may be provided if it is determined that the actual external voltage is higher than what would be required by the charge pump. For example, if a voltage level of approximately 3.0 volts were required or desired for the operation of the LCD array and the input voltage were in the range of 2.0 volts, the charge pump will be required to combine the 2× pumping operation.

However, if the external voltage were already at 3.0 volts or higher, it would not be necessary to activate the charge pump operation, as the charge pump is essentially a switched capacitor operation that would essentially provide a series switched capacitor resistor with a value of (1/Cf) in series with the output. Thus, if the external voltage were 4.0 volts, for example, the charge pump would provide a maximum voltage of 8.0 volts which would be regulated by the loop control described herein. By providing an external resistor 408 that can be switched with the switch 409, an external voltage of 4.0 volts can be switched under control of the AND gate output 470 and connect the voltage VDD_EXT to the resistor 408. This would basically provide the charging input to the capacitor 413 through the pad 412. It is noted that the reason for providing this ability to switch in the external voltage (when it is at an appropriately high value) directly to the pad 412 is to not utilize the charge pump 402, since the charge pump 402 can be inefficient and be a source of power consumption, which in low power devices is to be avoided if VDD_EXT is appropriate for the task.

The voltage VLCD from the multiplexer 406 is also provided to a resistor string 422 that is used for generating the various voltages that are applied as LCD drive voltages to the segments of the LCD display. The resistor string 422 is connected between node 424 within the pad 412 and ground. The resistor string 422 consists of a first resistor 426 connected between node 424 and node 428. A second resistor 430 connected between nodes 428 and 432 is half the value of the resistor 426. A third resistor 434 having the same value as resistor 430 is connected between node 432 and node 436. A resistor 438 having the same value as resistor 426 is connected between node 436 and the ground node.

The voltage provided from node 428 comprises two thirds of the VLCD voltage. The voltage provided from node 432 comprises one-half the voltage VLCD. The voltage provided from node 436 comprises one-third the VLCD voltage, and the voltage from the ground node is “0” volts. Each of these voltages from the resistor string are provided as various output voltages for providing control signals for the segment and COM signals. The voltage V ⅔ from node 428 is provided through a buffer 418. The output of the buffer 418 is connected to one input each of a pair of multiplexers 440 and 442. Each of the multiplexers 440 and 442 includes two inputs. The first input receives the buffered V ⅔ voltage from the resistor string 422 and the other input is connected to receive the control signal I_{DAC}. The output of multiplexer 440 comprises either the I_{DAC} output or the V⅔ output and is labeled LCD-CSB. The output from multiplexer 442 comprises either the I_{DAC} output or the V⅔ output and is labeled LCD-CS. A further multiplexer 444 is connected to receive the V ½ output from node 432 and the V ⅓ output from node 436. The output of the multiplexer 444 is provided to a buffer 420. The buffered output from buffer 420 of the voltage signal selected by multiplexer 444 is provided as the output voltage signal LCD_V1. The output voltage of the ground node is referred to as LCD_V0.

The resistor string 422 comprises a variable resistor string which may be tapped at many locations along its length by an input of a multiplexer 446 which has a plurality of selectable inputs 447, each connected to a predetermined position along resistor string 422. The output of the multiplexer 446 is used for adjusting contrast control from the output of the resistor string 422 and selects one of sixteen signals from inputs 447 responsive to a control input from contrast control block 448. The output of the contrast control block 448 enables the multiplexer 446 to select one of the inputs 447 to the multiplexer 446 that is connected to the resistor string 422 at a desired input point. The contrast control block 448 selects the appropriate contrast input responsive to a contrast control signal provided via input 450 and hysteresis control input received from node 452. This contrast control essentially allows control of VLCD in discrete steps.

The output of the multiplexer 446 is provided to a first input of a comparator/latch 454. The other input of the comparator/latch 454 is connected to a reference voltage V_{REF}. The output of the comparator/latch 454 is connected to a D-input of a flip-flop 456. Both the comparator/latch 454 and the flip-flop 456 receive a clock input from a clock control block 458. The clock control block 458 receives a clock signal from either an internal real time clock 460 or an external clock 462, one of which is selected via a multiplexer 464, this being a low frequency clock signal around 32 KHz. The reference voltage V_{REF} provided to the comparator/latch 454 is provided from a bandgap circuit 466 such that it is a stable and known voltage. The bandgap circuit 466 provides the V_{REF} voltage and various bias voltage outputs responsive to a VDD_EXT signal. The n-well control block 468 provides various switching control signals responsive to the VDD_EXT signal and the VLCD drive voltage.

The Q-output of flip-flop 456 is provided to a first input of AND gate 470. The other input of AND gate 470 is connected to receive the LCD enable control signal (LCDEN) to enable/disable the LCD. The output of the AND gate 470 enables the oscillator 472. The oscillator 472 provides a clock signal PMPCLK to the clock generation and level shift logic 474 that generates signals to enable the operation of the charge pump 402. Each of the clock generation and level shift logic 474, oscillator 472 and flip-flop 456 are reset responsive to a reset signal provided to an AND gate 476. The AND gate 476 is connected to receive a WDT signal (watch dog timer) on a first non inverted input and a reset signal on an inverted input to either reset the system when some unknown state has caused a failure, or in response to an external reset signal.

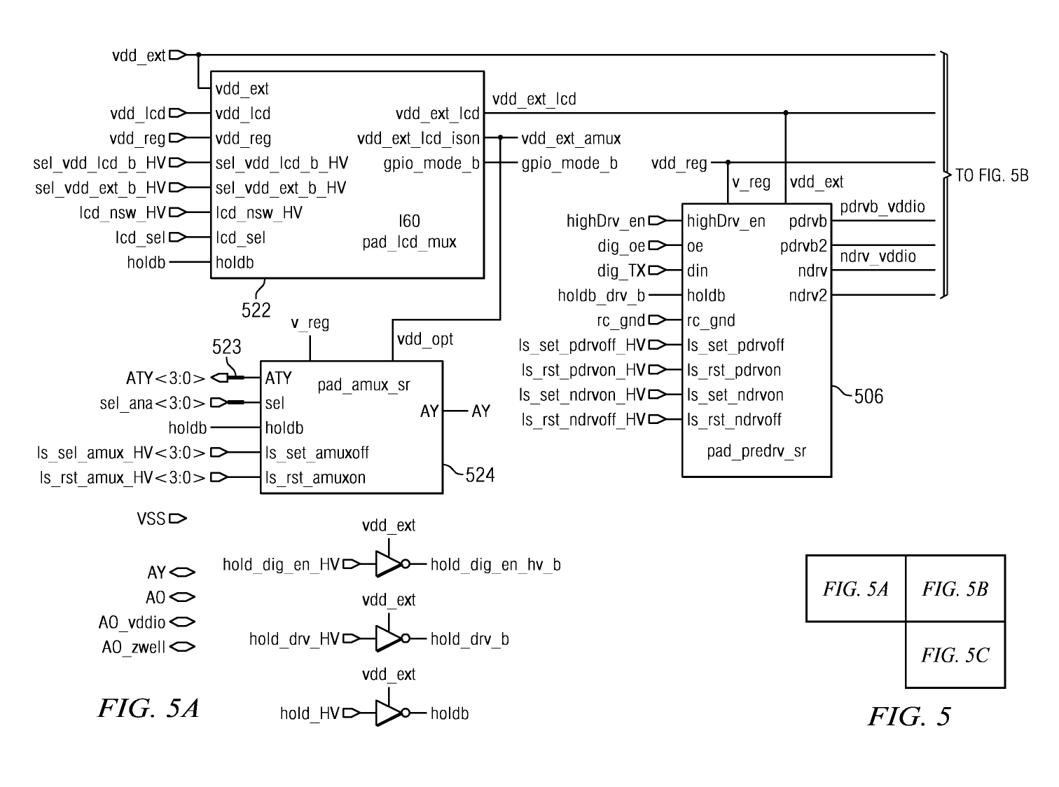

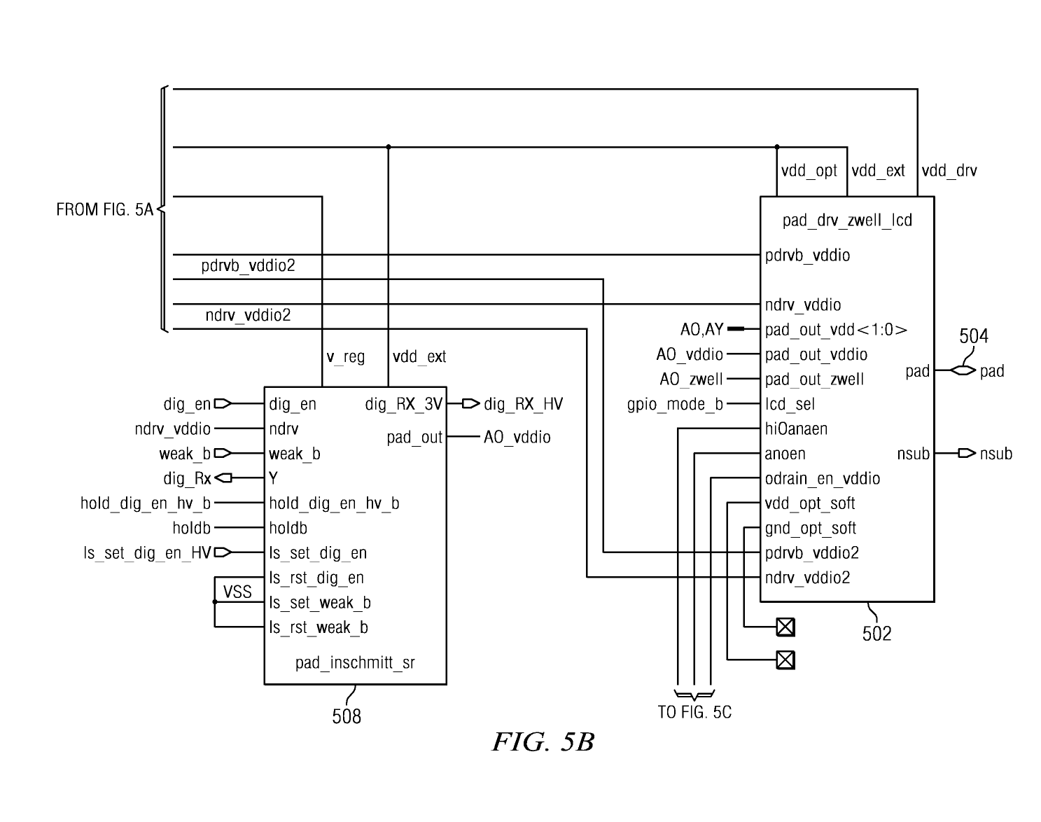

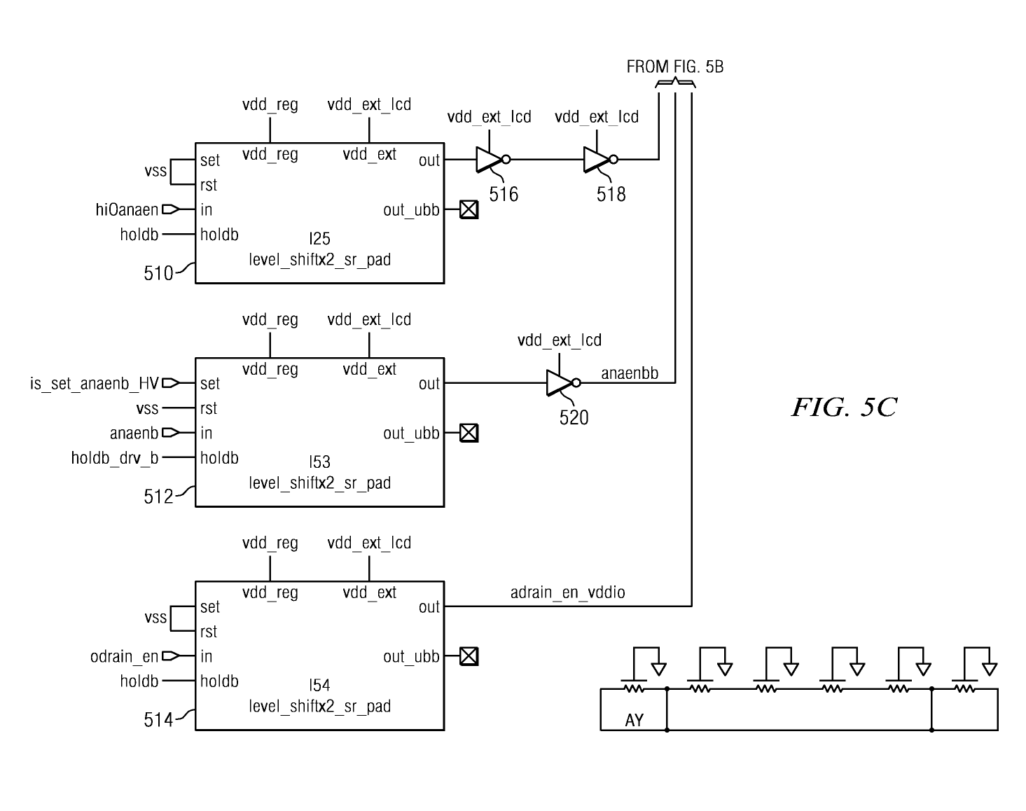

Referring now to FIG. 5, there is illustrated an upper level block diagram of the pad logic for controlling the operation of the GPIO pins 158. The pad logic would be incorporated within the port drivers 156 (FIG. 1). The pad and LCD driver block 502 provides the output to and receives the input from the pad input 504. The pad input 504 would be connected with one of the GPIO pins 156. Signals that are being transmitted out by the driver block 502 first pass through a pad pre driver block 506. A schmitt driver block 508 controls the switching of various digital signals that are provided to the pad driver block 502.

A plurality of level shifters 510, 512 and 514 are connected to provide level shifted signals to the pad driver block 502. The level shifter 510 has its output connected to a first inverter 516. The input of the level shifter 510 is connected to the HIQANDEN signal. The output of the inverter 516 is connected to the input of a second inverter 518 whose output is connected to the HIQANDEN input of the pad driver 502. The level shifter circuit 512 has its input connected to receive the ANAENB signal. The output of the level shifter 512 is connected to the input of an inverter 520. The output of the inverter 520 is connected to the ANDEN input of the driver block 502. The level shifter 514 is connected to receive the ODRAIN_EN input and the output of the level shifter 514 is connected to the ODRAIN_EN_VDDIO input of the pad driver block 502.

The pad multiplexer 522 is used for selecting the system voltage that is to be applied to the various circuits of the pad driver logic including the n-wells. The pad multiplexer block 522 determines which of the VDD_EXT voltage or the VLCD voltage provided from the charge pump is higher and applies the higher of these two voltages to the system components. The pad analog multiplexer 524 is responsible for selecting V_{OUT} between V₁-V₄. The analog multiplexer 524 is operable to receive the voltage V₁-V₄ on inputs 523 labeled ATY <3:0> and selects one of these outputs based on a SEL signal sel_ana <3:0>. The output is provided on an output AY. Also, the pad multiplexer 552 outputs a voltage VDD_EXT_AMMX for input to the analog multiplexer 524 when it is active to ensure that the output voltage is the higher of VDD_EXT or VLCD.

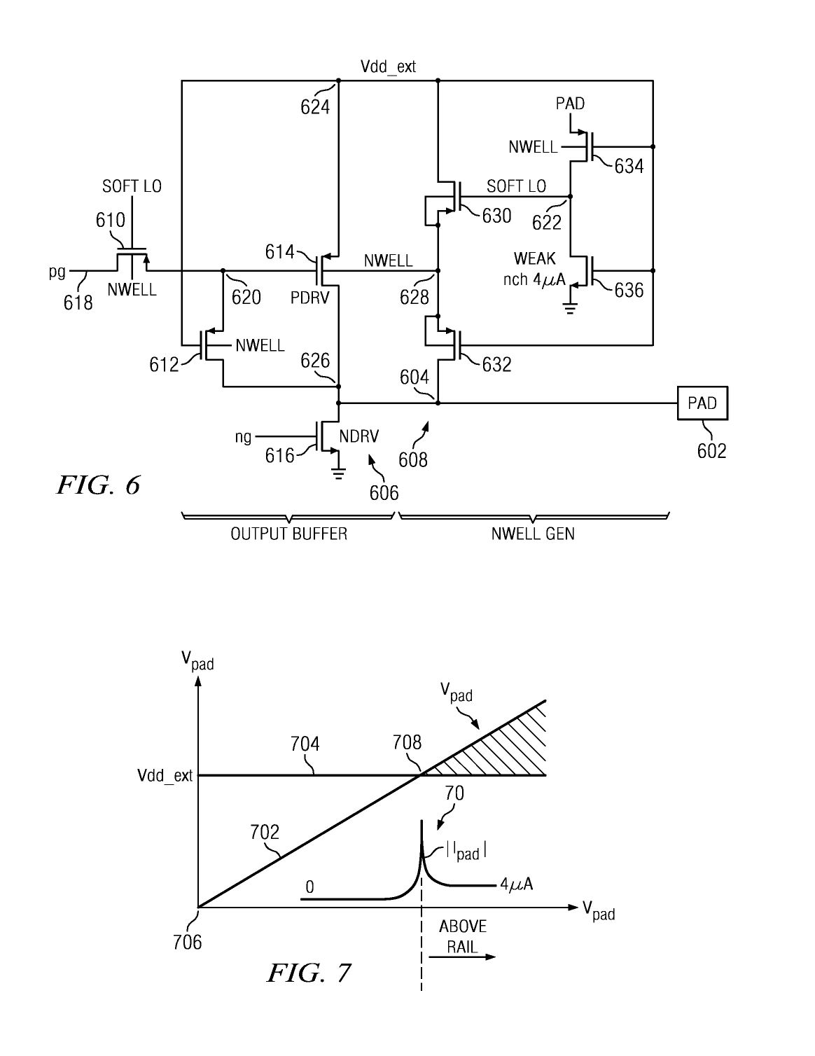

Referring now to FIG. 6, there is illustrated a schematic diagram of the circuitry associated with the output pad 602 that controls the n-well voltages. The circuitry of FIG. 6 is associated with the pad 602 and is connected thereto at a node 604. The circuit comprises an output buffer portion 606 and an n-well generator portion 608. The output buffer portion 606 consists of P-channel transistor 610, P-channel transistor 612, P-channel transistor 614 and N-channel transistor 616. The output buffer 606 is responsible for driving output signals that are being transmitted from the pad 602. The PG input provides a P-channel transistor drive voltage to the drain of P-channel transistor 610 that is connected between node 618 and node 620. The gate of transistor 610 is connected to receive a soft low signal from node 622 which is present when the pad voltage is below VDD_EXT. The gate of a P-channel transistor 614 is connected to node 620. The source/drain path of the transistor 614 is connected between the VDD_EXT node 624 and node 626. Transistor 612 has its gate connected to the VDD_EXT node 624 and its source/drain path connected between node 620 and node 626. The n-well of transistors 610, 612 and 614 are each interconnected with each other at node 628. Transistor 616 comprises an N-channel transistor having its drain/source path connected between node 626 and a ground node. The gate of transistor 616 is connected to the NG signal to provide an N-channel drive voltage.

When the pad voltage is low, then transistor 634 is off and transistor 610 is on to allow transistor 614 to drive pad 602, depending upon the voltage level of PG. When the pad voltage is above the rail voltage, then transistor 634 is turned on and transistor 610 is turned off so no driving voltage is applied to transistor 614. Also, transistor 612 is turned on, ensuring that transistor 614 is turned off.

The n-well generator 608 is used for controlling the voltage that is being applied to the n-wells of the transistors of the output pad logic. The n-well generator 608 consists of P-channel transistor 630, P-channel transistor 632, P-channel transistor 634 and N-channel transistor 636. P-channel transistor 630 has its drain/source path connected between the VDD_EXT node 634 and node 628. P-channel transistor 632 has its source/drain path connected between node 628 and is connected to the pad 602 at node 604. The gate of transistor 630 is connected to node 622 while the gate of transistor 632 is connected to the VDD_EXT node 624. The n-wells of each of transistors 630 and 632 are connected with the n-well node 628. Transistor 634 has its source/drain path connected between the pad 602 at node 604 and node 622. The gate of transistor 634 is connected to the VDD_EXT node 624 and its n-well is connected to node 628. Transistor 636 comprises a weak N-channel transistor having its drain/source path connected between node 622 and ground. The gate of transistor 636 is connected to the VDD_EXT node 624.

The n-well generator circuit 608 controls whether the VDD_EXT voltage applied at node 624 or the pad voltage applied at node 604 is applied to the n-wells of the transistors within the pad logic circuitry. When the pad voltage is below the VDD_EXT voltage, the VDD_EXT voltage is applied to each of the n-wells of the various transistors. This causes transistor 632 to be turned off while transistor 630 is turned on. This provides the VDD_EXT voltage from node 624 to the n-well node 628 to which each of the n-wells of the various transistors are connected. The transistor 634 is turned on when the VDD_EXT voltage is exceeded by the pad voltage while the weak N-channel transistor 636 is weakly turned on, but the gate of transistor 630 is pulled high by transistor 634, overcoming the soft low of transistor 636. This turns off transistor 630 and pulls node 628 to the pad voltage through transistor 632. Thus, in this state, the n-wells of each of the transistors are driven to the pad voltage level through transistor 632.

When the pad voltage applied to the pad 602 begins to approach the level of VDD_EXT and finally exceeds the VDD_EXT voltage, the n-well generator circuitry 608 will begin the process of switching the n-well voltage from VDD_EXT to the pad voltage. As the pad voltage begins exceeding VDD_EXT, transistor 632 begins to turn on. As the transistor 632 turns on, the transistor 632 competes for control of node 628 with transistor 630. Eventually, when the transistor 632 turns fully on, node 628 will be driven to the pad voltage once transistor 630 turns off as described below. As transistor 632 begins to turn on, transistor 634 also begins to turn on responsive to the increased pad voltage at the source of the transistor 634. As mentioned previously, transistor 636 provides a soft low signal at node 622 and as transistor 634 begins turning on, it begins to compete with transistor 636 for control of node 622. Once transistor 634 is completely turned on, it will pull node 622 from the soft low level to the pad voltage level. Node 622 going to the pad voltage level will turn off transistor 630. Once transistor 630 is off, node 628 is disconnected from VDD_EXT and transistor 632 connects node 628 to the pad voltage at node 604. Thus, all n-wells connected to node 628 are now at the pad voltage rather than the VDD_EXT voltage.

This operation of the pad logic circuitry creates a current spike at the pad 602 as is more fully illustrated in FIG. 7. As can be seen, the VPAD voltage 702 increases toward the level of VDD_EXT from point 706 to point 708. When the VPAD voltage exceeds VDD_EXT at point 708, this causes a current spike at the pad 602 as indicated generally at 710. Even after the current spike has decayed, a 4 micro amp current is provided at the pad 602. This current is caused by the weak N-channel transistor 636 which remains on even once the n-well voltage switches from the VDD_EXT level to the VPAD level causing current to flow from the pad through transistors 634 and 636. This 4 micro amp current and the current spike 710 at the pad 602 can cause problems when the GPIO pin associated with the pad 602 is operating as an LCD driver. This will cause a higher current draw, which is undesirable in a low power operating environment However, when the pad 602 is operating as a GPIO pin and not as an LCD driver, the additional currents will not cause any problems to the connected components. Thus, there is a need for determining some manner for limiting the leakage currents from the pad 602 depending on whether these currents will be too high for power concerns.

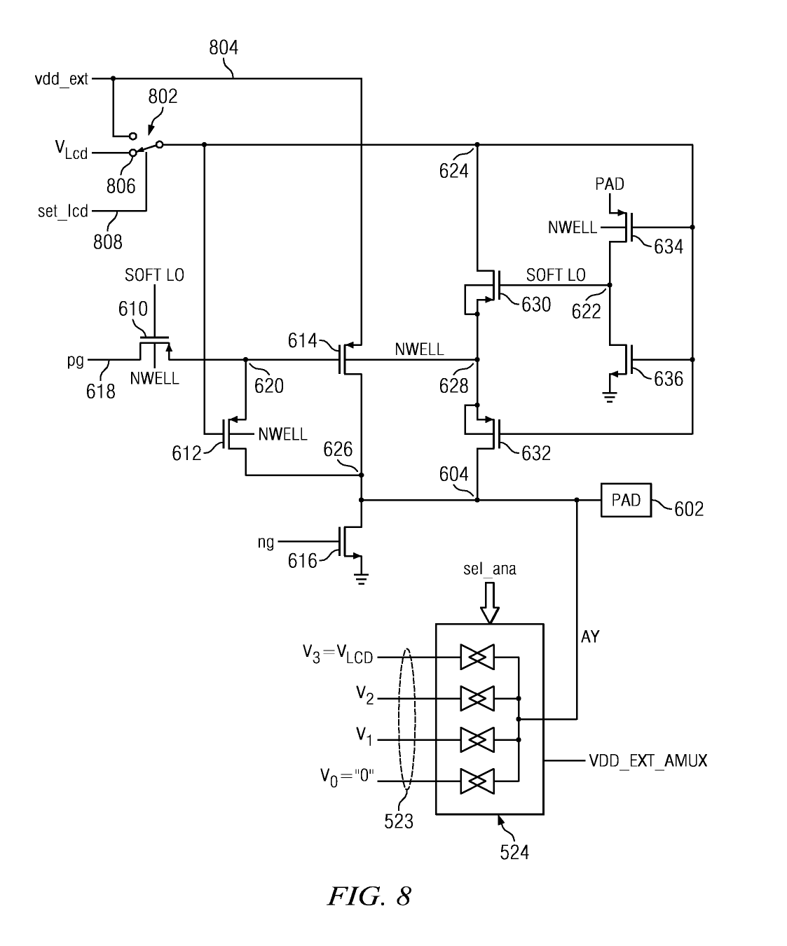

Referring now to FIG. 8, there is illustrated the manner for modifying the circuitry of FIG. 6 to remove the problem associated with the current spike and leakage current caused by transistor 636 when the pad 602 is being utilized to drive a liquid crystal display. The circuit comprises an output buffer portion 606 and an n-well generator portion 608. The output buffer portion 606 consists of P-channel transistor 610, P-channel transistor 612, P-channel transistor 614 and N-channel transistor 616. The output buffer 606 is responsible for driving output signals that are being transmitted from the pad 602. The PG input provides a P-channel transistor drive voltage to the drain of P-channel transistor 610 that is connected between node 618 and node 620. The gate of transistor 610 is connected to receive a soft low signal from node 622 which is present when the pad voltage is below VDD_EXT. The gate of a P-channel transistor 614 is connected to node 620. The source/drain path of the transistor 614 is connected between the VDD_EXT node 624 and node 626. Transistor 612 has its gate connected to the VDD_EXT node 624 and its source/drain path connected between node 620 and node 626. The n-well of transistors 610, 612 and 614 are each interconnected with each other at node 628. Transistor 616 comprises an N-channel transistor having its drain/source path connected between node 626 and a ground node. The gate of transistor 616 is connected to the NG signal to provide an N-channel drive voltage.

The n-well generator 608 is used for controlling the voltage that is being applied to the n-wells of the transistors of the output pad logic. The n-well generator 608 consists of P-channel transistor 630, P-channel transistor 632, P-channel transistor 634 and N-channel transistor 636. P-channel transistor 630 has its drain/source path connected between the VDD_EXT node 634 and node 628. P-channel transistor 632 has its source/drain path connected between node 628 and is connected to the pad 602 at node 604. The gate of transistor 630 is connected to node 622 while the gate of transistor 632 is connected to the VDD_EXT node 624. The n-wells of each of transistors 630 and 632 are connected with the n-well node 628. Transistor 634 has its source/drain path connected between the pad 602 at node 604 and node 622. The gate of transistor 634 is connected to the VDD_EXT node 624 and its n-well is connected to node 628. Transistor 636 comprises a weak N-channel transistor having its drain/source path connected between node 622 and ground. The gate of transistor 636 is connected to the VDD_EXT node 624.

The analog multiplexer for each pad has the output thereof connected to the node 604. When active, it will select between one of the four input voltages for output therefrom and the associated output pad will be driven with the selected output voltage.

The configuration of FIG. 6 is modified such that a switching multiplexer 802 (or some other type of switch) is connected between node 624 and the connection to either VDD_EXT at node 804 and VLCD at node 806. The source of transistor 614, rather than remaining connected to node 624 is connected with node 804 such that the source remains connected to VDD_EXT in all conditions. However, the gate of transistor 612, the drain of transistor 630 and the gates of transistors 634, 636 and 632 are now connected to either VDD_EXT or VLCD depending upon the type of components that the pad 602 is driving. The multiplexer 802 is operable to determine if the LCD mode is detected for the given pad and also to determine the higher of the VDD_EXT or VLCDON to connected to node 624. Control of the multiplexer 802 is provided by the SET_LCD signal via input 808. The generation of the control signal SET_LCD will be described more fully herein below.

As described previously with respect to FIG. 5, when the pad voltage VPAD does not exceed the voltage VDD_EXT, transistor 614 is controlled by the voltage PG and transistor 630 is turned on while transistor 632 is turned off. This provides that the n-wells of each of the transistors within the circuitry are connected with VDD_EXT. In this case, the problems arising when the pad voltage VPAD exceeds VDD_EXT do not arise and there is no need to overcome the problem caused by leakage currents generated by transistor 636. However, once the pad voltage VPAD exceeds the rail voltage VDD_EXT as described previously with respect to FIG. 7, transistors 632 and 634 will be turned on and transistors 630 and 614 will be turned off. In this state, there could be a problem with respect to leakage currents when the pad is driving an LCD. As mentioned, this problem is only relevant if the pad is being used to drive a liquid crystal display. When driving the LCD display, node 624 is connected to the higher of VDD_EXT or VLCDat node 624 responsive to a SET_LCD control signal on line 808. This connects the higher voltage to node 624 and eliminates the problem caused by the leakage currents by having the n-well voltages equal to or less than the pad voltage. Since the higher voltage is now applied at node 624, the voltage at node 624 will never be exceeded by the voltage at the pad 602 because the highest voltage applied to the pad 602 is the voltage VLCD when the pad is being used to drive a liquid crystal display. This will eliminate the occurrence of the leakage currents through the pad as described previously. It is not necessary to connect the source of transistor 614 to VLCD in order to prevent the leakage current problems.

Alternative embodiments might attempt to place a switch at node 604 rather than using the embodiment discussed herein above. While this is one possible implementation, this solution suffers from the problem that the addition of the transistor at node 604 would affect the driver output capabilities of the driver transistor 614 and the driver transistor 616. Addition of the switching transistor at node 604 would require transistors 614 and 616 to be larger in order to provide similar operating performance. This would, of course, require increased board size, which is undesirable.

An additional solution involves merely placing a multiplexer or switch at node 624 of FIG. 6, as originally configured. This would involve additionally connecting the transistor 614 to the node that was switched rather than maintaining its connection to VDD_EXT. However, by placing this switch in series with transistor 614, this would again affect the drive capabilities of transistor 614 requiring a larger transistor 614 to be used in order to achieve the same system performance that was available without a switch placed at node 624. By placing the multiplexer switch 802 at node 624 and connecting the source of transistor 614 to remain in contact with VDD_EXT, the adverse affects on the output drive capabilities of the output buffer are minimized.

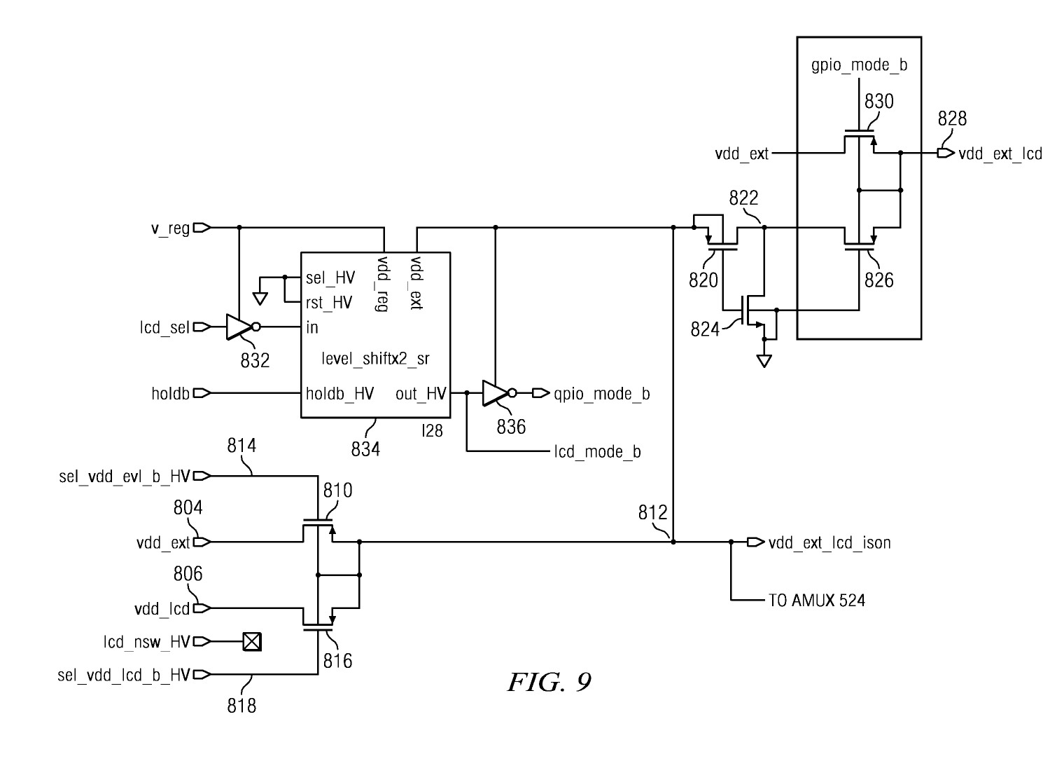

Referring now to FIG. 9, there is illustrated a schematic block diagram of the multiplexer 802 that is used for selecting between the VDD_EXT voltage and the LCD voltage for application to node 624 (FIG. 8) responsive to the SEL_LCD signal on line 808. (This provides the functionality of pad multiplexer 522 of FIG. 5) The VDD_EXT signal is applied at node 804 to a transistor 810. The transistor 810 is a P-channel transistor and has its drain/source path connected between node 804 and node 812. The gate of transistor 810 is connected to receive the control signal SEL_VDD_EXT_B on input 814. The VDD_LCD signal is applied at node 806 to a transistor 816. Transistor 816 is a P-channel transistor having its drain/source path connected between node 806 and node 812. The gate of transistor 816 is connected to receive the SET_VDD_LCD_B signal on input 818. The signals SEL_VDD_EXT_B and SEL_VDD_LCD_B comprise the SEL_LCD signals described previously with respect to FIG. 8. These signals are always inverse from each other such that when the SEL_VDD_EXT_B signal is at a logical “high” level, the SEL_VDD_LCD_B signal is at a logical “low” level, and vice versa. In this manner, only one of the VDD_EXT or VDD_LCD signals are applied to node 812 through the transistors 810 and 816 to drive the voltage input of the analog multiplexer 524. It should be understood that other methods to achieve the same result to select/switch between two (or more) input voltage levels and an output driving voltage level.

The selected signal is based on which of the VDD_EXT voltage or VDD_LCD voltage is higher as will be described more fully below. Transistor 820 comprises a P-channel transistor which has its source/drain path connected between node 812 and node 822. An N-channel transistor 824 has its gate connected to the gate of transistor 820 and its drain/source path connected between node 822 and ground. Transistor 826 is a P-channel transistor having its drain/source path connected between node 822 and the output node of the multiplexer 828, thus connected to node 624. The gate of transistor 826 is connected to the gate of transistor 824. Transistor 830 is a P-channel transistor having its drain/source path connected between VDD_EXT and node 828. The gate of transistor 830 is connected to receive the control signal GPIO_MODE_B and will select VDD_EXT when the gate is low.

The multiplexer 802 also receives an LCD_SELECT signal which provides an indication of whether the GPIO pad 602 is actually selected to drive a liquid crystal display. The LCD_SELECT signal is provided to the input of an inverter 832. The output of the inverter is connected to a level shifter circuit that provides its output to a second inverter 836. The output of the inverter 836 is provided to the input of transistor 830. When the LCD select signal is at a logical “high” level, indicating that the pad is selected to drive a liquid crystal display, transistor 830 is turned off responsive to the output of inverter 836 enabling the selected voltage of VDD_EXT or VDD_LCD to be output from node 812 through node 828. When the LCD select input at the input of inverter 832 is at a logical “low” level, indicating that the pad output is not selected to drive a liquid crystal display, the output of inverter 836 will turn off transistor 830 and not enable the voltage at node 812 to be passed through to node 828. This will arise in the situation wherein the pad 820 had the ability to operate as an LCD driver but was not selected to do so at the particular point in time.

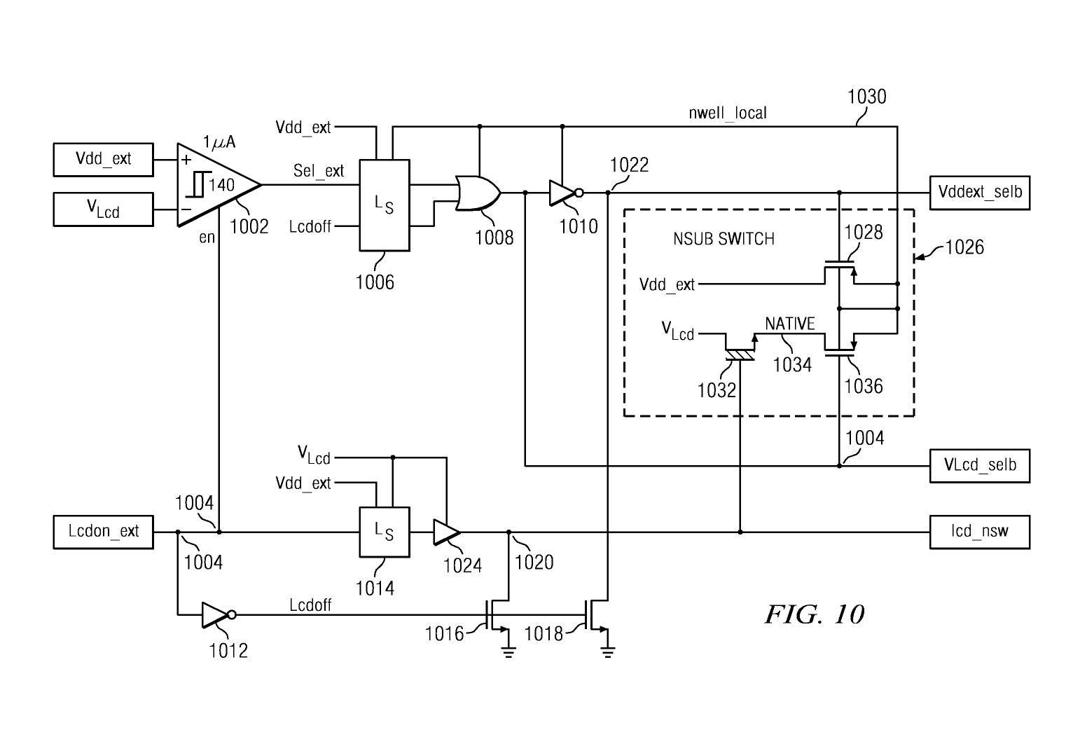

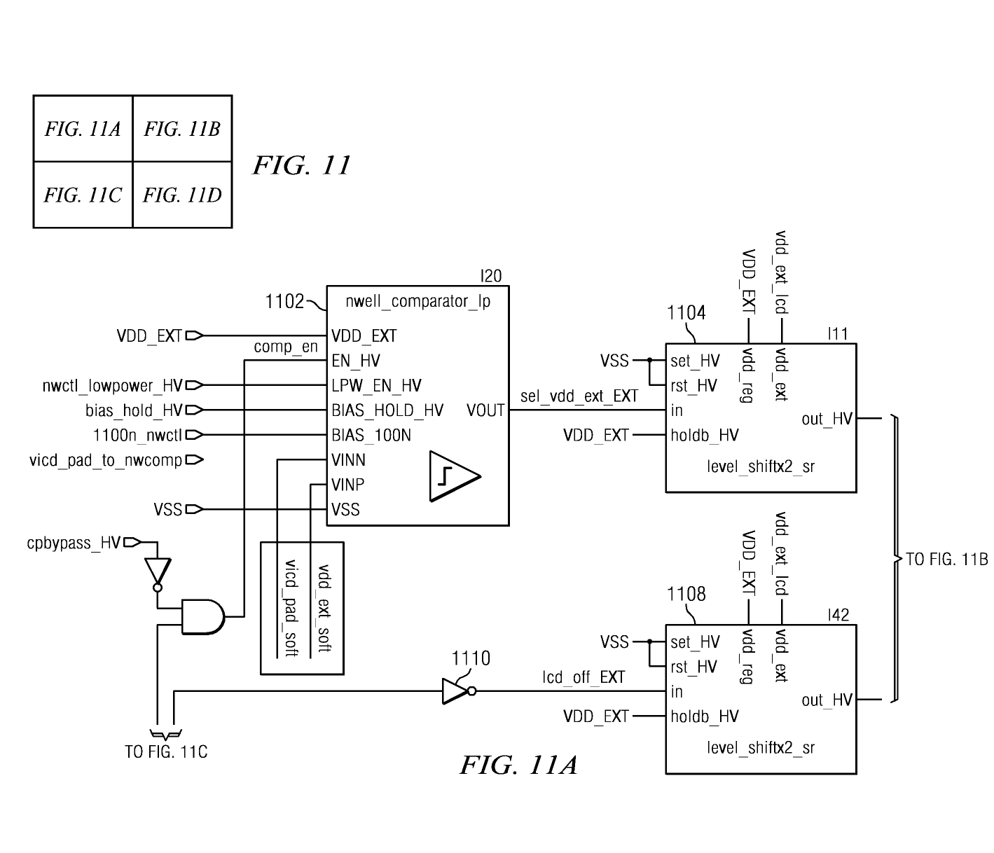

Referring now to FIG. 10, there is illustrated the n-well control block 468 that was described previously with respect to FIG. 4. The n-well control block 468 generates the VDD_SEL_B and VLCD_SEL_B control signals that are applied to the multiplexer circuit at nodes 804 and 806 of FIG. 9 in order to apply the proper voltage to the n-wells of FIG. 5. The n-well control block 768 generates the control signals based upon a determination of whether the VDD_EXT voltage or the VLCD voltage is higher. This is determined by applying the VDD_EXT voltage at a non-inverting input of hysteresis controlled comparator 1002. The inverting input of the hysteresis controlled comparator 1002 is connected to receive the VLCD voltage. When the comparator 1002 is enabled responsive to an enable signal applied at node 1004, the comparator 1002 determines whether the VLCD voltage is greater than the VDD_EXT voltage. The enable signal is provided to indicate that the LCD function is on.

The output of the comparator 1002 goes to a logical “high” level when the VDD_EXT signal is greater than the VLCD signal. When the VLCD signal is greater than the VDD_EXT voltage, the output of the comparator 1002 will go to a logical “low” level. The output of the comparator 1002 is applied to a level shifter circuit 1006. A second input of the level shifter circuit 1006 is connected to receive an LCDOFF signal, indicating that the LCD capability is disabled. A first input of an OR gate 1008 is connected to receive the level shifted output of the comparator 1002 and the level shifted version of the LCDOFF signal. The OR gate 1008 enables the output selection of the comparator 1002 to be disabled if an LCDOFF indication is being provided at the one input of the OR gate 1008. The output of the OR gate 1008 is connected to the input of an inverter 1010. The output of the inverter 1010 comprises the VDD_EXT_SEL_B selection signal that is provided to the input at node 814 of the pad multiplexer of FIG. 9. The output of the OR gate 1008 comprises the VLCD_SEL_B control signal that is applied to node 818 of the pad multiplexer of FIG. 9. It should be understood that other techniques could be implemented to achieve the same result.

The LCD_ON_EXT signal is applied at node 1004. The LCD_ON_EXT signal, as described previously, is used to enable the comparator 1002 and is applied to the input of an inverter 1012 and to a level shifter 1014. The output of the inverter 1012 comprises the LCDOFF signal which is also applied as an input to the level shifter 1006 as discussed previously. The output of inverter 1012 is also connected to the gates of transistors 1016 and 1018. Transistor 1016 has its drain/source path connected between node 1020 and ground. Transistor 1018 has its drain/source path connected between the output of inverter 1010 and at node 1022 and ground. The level shifted output from level shifter 1014 is applied to an amplifier 1016 which has its output connected to node 1020.

An N-sub switch 1026 is connected between the output node for the VDD_EXT_SEL_B signal, the node for the VLCD_SEL_B signal and node 1020 which provides the LCD_NSW signal. The N-sub switch 1026 is used to independently provide local n-well bias to node 1030 and inverter 1010 and OR gate 1008. The N-sub switch 1026 includes a transistor 1028 comprising a P-channel transistor having its drain/source path connected between VDD_EXT and node 1030 comprising the local n-well connection. A native N-channel transistor 1032 has its drain/source path connected between VLCD and node 1034. The gate of transistor 1032 is connected to node 1020. The gate of transistor 1028 is connected to node 1022, the VDD_EXT_SEL_B node. A transistor 1036 is a P-channel transistor having its drain/source path connected between node 1034 and node 1030. The gate of transistor 1036 is connected to the VLCD_SEL_B node 1009. The N-sub switch will connect either VLCD or VDD_EXT to the local n-well connection on node 1030.

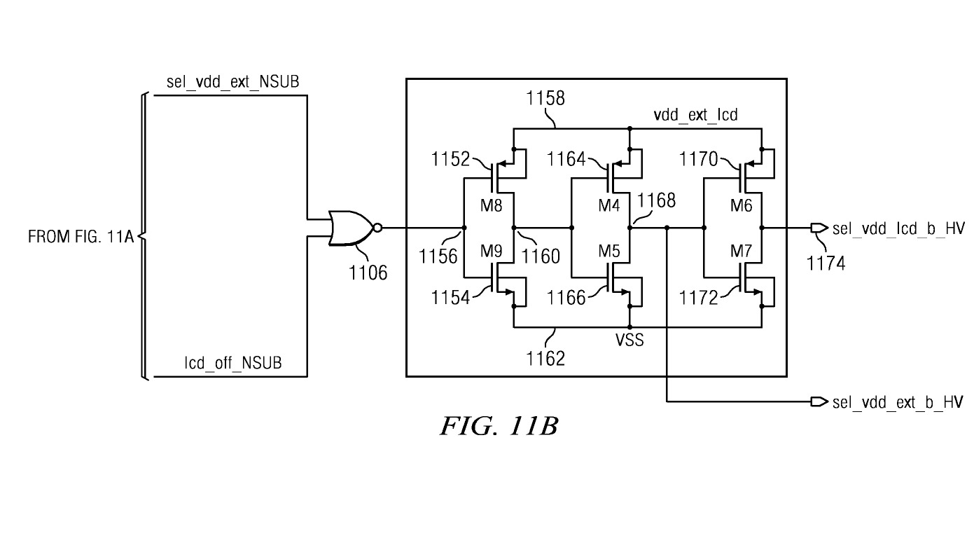

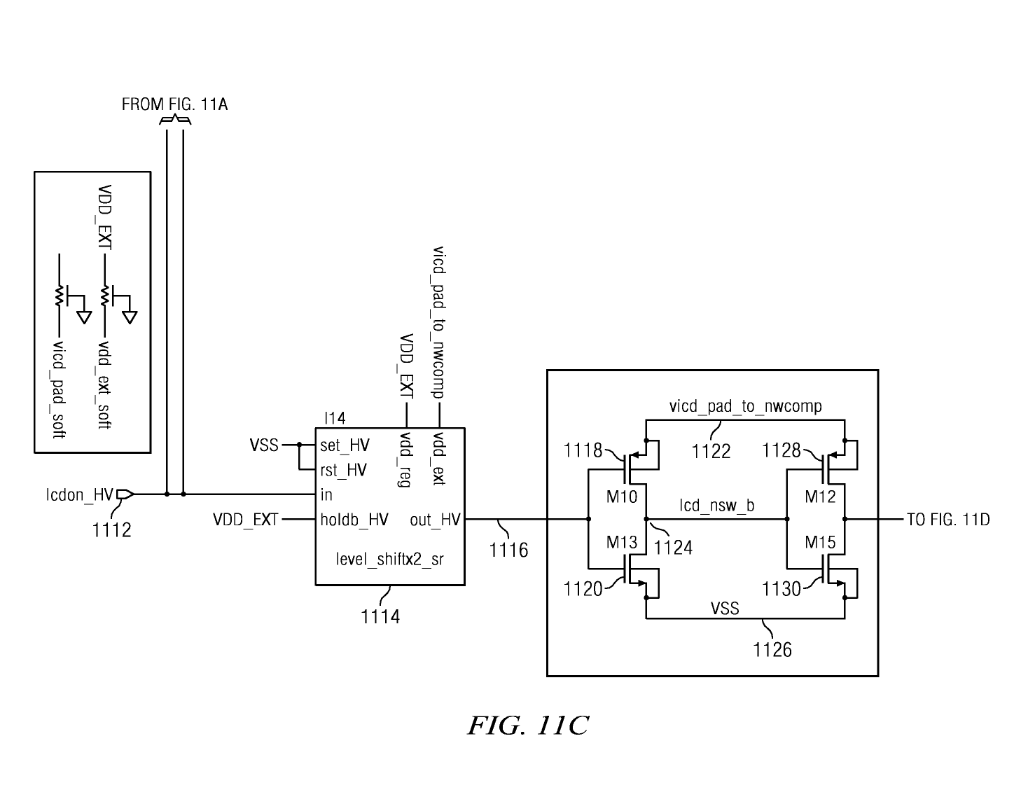

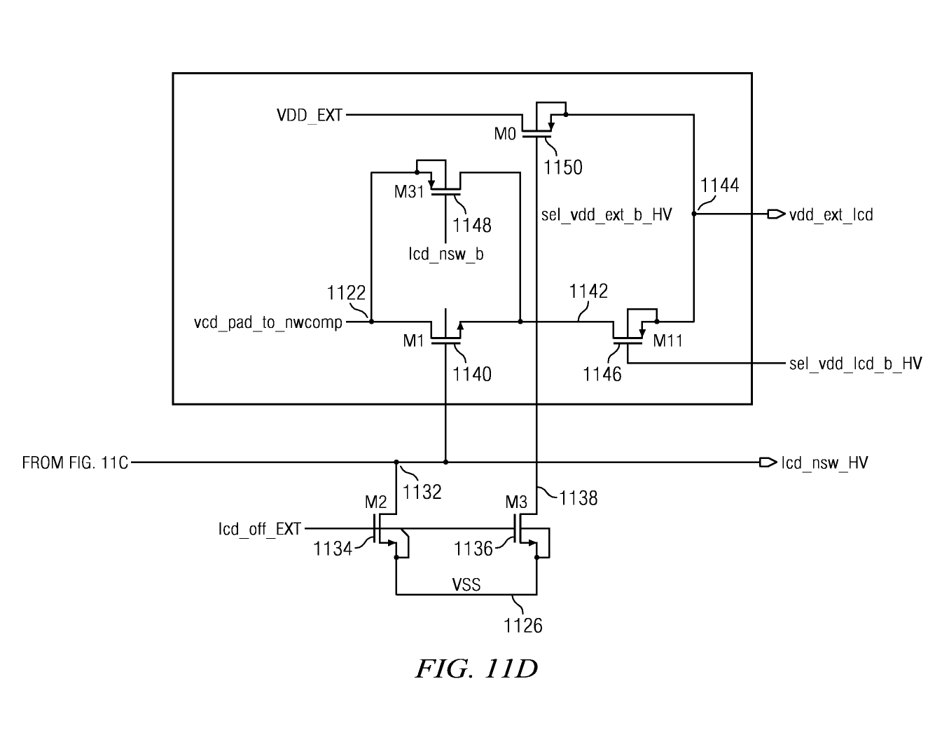

Referring now to FIG. 11, there is more particularly illustrated a schematic diagram of the n-well control block 468 of FIG. 4 corresponding to the logic diagram of FIG. 10. The VDD_EXT and VLCD signals are applied to respective inputs of comparator 1102. The output of comparator 1002 is connected to a level shifter block 1104. The output of the level shifter block is provided to one input of a NOR gate 1106. The other input of NOR gate 1106 is connected to receive an output from a level shifter block 1108. The input of the level shifter block 1108 is connected to the output of an inverter 1110 that has the input thereof connected to the LCD display input LCDON_HVon input node 1112. The input at node 1112 is also provided to level shifter 1114. The output of the level shifter 1114 is connected to node 1116. The gates of transistors 1118 and 1120 are connected to node 1116. Transistor 1118 comprises a P-channel transistor connected between node 1122 and node 1124. Transistor 1120 comprises an N-channel transistor having its drain/source path connected between node 1124 and the VSS node 1126. Connected in parallel with transistors 1118 and 1120 are P-channel transistor 1128 and N-channel transistor 1130 between nodes 1122 and node 1126. Transistor 1128 and 1130 are connected in series at node 1132. A transistor 1134 is an N-channel transistor having its drain/source path connected between node 1132 and VSS node 1126. The gate of transistor 1134 is connected to receive the LCD_OFF_EXT signal. Transistor 1136 has its drain/source path connected between node 1138 and the VSS node 1126. The gate of transistor 1136 is connected to the LCD_OFF_EXT signal. Transistor 1140 is an N-channel transistor having its drain/source path connected between node 1122 and node 1142. The gate of transistor 1140 is connected to node 1132. Connected between node 1142 and the VDD_EXT_LCD_OUTPUT control signal 1144 is a transistor 1146. Transistor 1146 comprises an N-channel transistor having its drain/source path connected between node 1142 and node 1144 and having its gate connected to the SEL_VDD_LCD_V_HV signal at node 1138. A transistor 1148 has its source/drain path connected between node 1122 and node 1142 in series with transistor 1140. Transistor 1148 comprises a P-channel transistor. P-channel transistor 1150 has its gate connected to node 1138 and its drain/source path connected between VDD_EXT and node 1144.

The output of NOR gate 1106 is connected to the gates of series connected transistors 1152 and 1154 at node 1156. Transistor 1152 comprises a P-channel transistor having its source/drain path connected between the voltage VDD_EXT_LCD at node 1158 and node 1160. Transistor 1154 has its drain/source path connected between node 1160 and node 1162, the VSS node. The gate of a series connection of transistors 1164 and 1166 have their gates connected to node 1160 and transistors 1164 and 1166 are configured in the same manner as transistors 1152 and 1154. A third pair of transistors 1170 and 1172 are connected to transistors 1164 and 1166 at node 1168 and are configured in the same manner as transistors 1164 and 1166. Transistors 1170 and 1172 are connected in series at node 1174 which comprises the SELECT_VDD_LCD_HV node which is the output of the highest of the selected voltages in the comparison between VDD_EXT and VLCD. Node 1168 comprises SEL_VDD_EXTERNAL_B which is the other signal used for selecting between the VDD_EXT and the VLCD signal.

It will be appreciated by those skilled in the art having the benefit of this disclosure that this voltage control on n-wells in multi-voltage environments provides an ability to alter the voltage applied to n-wells of the circuit depending on a pad voltage. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. Output pad control logic, comprising:
an output buffer including a plurality of transistors connected to drive signals for an output pad, each of the plurality of transistors including an n-well;
an n-well generator for connecting a first voltage to the n-wells of the plurality of transistors of the output buffer in a first mode of operation when a system rail voltage exceeds a pad voltage applied to the output pad and for connecting the pad voltage to the n-wells of the plurality of transistors of the output buffer in a second mode of operation when the pad voltage applied to the output pad exceeds the system rail voltage; and
a switching circuit responsive to at least one control signal for connecting the system rail voltage as the first voltage when the output pad is not driving an LCD display and for connecting a larger of the system rail voltage and an LCD drive voltage as the first voltage when the output pad is driving the LCD display.

2. The output pad control logic of claim 1, wherein the switching circuitry comprises a multiplexer.

3. The output pad control logic of claim 1, wherein the switching circuitry further comprises:
first switching logic for selecting either the system rail voltage or the LCD drive voltage responsive to the at least one control signal; and
second switching logic for selecting the system rail voltage responsive to an indication that the output pad is not driving the LCD display and for selecting an output of the first switching logic responsive to an indication that the output pad is driving the LCD display.

4. The output pad control logic of claim 1 further including n-well control logic for generating the at least one control signals to connect the larger of the system rail voltage and the LCD drive voltage responsive to a determination of a higher of the system rail voltage and the LCD drive voltage.

5. The output pad control logic of claim 4, wherein the n-well control logic further comprises:
a comparator for comparing the system rail voltage and the LCD drive voltage and generating a level indication of which of the system rail voltage and the LCD drive voltage is higher;
n-well voltage selection control logic responsive to the level indication for generating a system rail voltage selection signal indicating whether to select the system rail voltage and for generating and LCD voltage selection signal indicating whether to select the LCD voltage; and
wherein the system rail selection voltage selection signal and the LCD voltage selection signal are always at different logic levels.

6. The output pad control logic of claim 5, wherein the n-well voltage selection logic further comprises control logic connected to receive the level indication and an LCD indication to indicate whether an LCD mode of operation for the output pad is enabled, the control logic generating the system rail voltage selection signal at a first logical level and the LCD voltage selection signal at a second logical level when either the system rail voltage exceeds the LCD drive voltage or when the LCD indication indicates the LCD mode of operation of the output pad is disabled, the control logic generating the system rail voltage selection signal at the second logical level and the LCD voltage selection signal at the first logical level when either the LCD drive voltage exceeds the system rail voltage or when the LCD indication indicates the LCD mode of operation of the output pad is enabled.

7. Output pad control logic, comprising:
an output buffer including a plurality of transistors connected to drive signals for an output pad, each of the plurality of transistor including an n-well;
an n-well generator for connecting a first voltage to the n-wells of the plurality of transistors of the output buffer in a first mode of operation when a system rail voltage exceeds a pad voltage applied to the output pad and for connecting the pad voltage to the n-wells of the plurality of transistors of the output buffer in a second mode of operation when the pad voltage applied to the output pad exceeds the system rail voltage;
first switching logic responsive to at least one control signal for selecting a larger of either the system rail voltage or the LCD drive voltage;
second switching logic responsive to the at least one control signal for selecting the system rail voltage responsive to an indication that the output pad is not driving the LCD display and for selecting an output of the first switching logic responsive to an indication that the output pad is driving the LCD display; and
n-well control logic for generating the at least one control signal to select the larger of the system rail voltage and the LCD drive voltage responsive to a determination of a higher of the system rail voltage and the LCD drive voltage.

8. The output pad control logic of claim 7, wherein the first switching logic and the second switching logic are included within a multiplexer.

9. The output pad control logic of claim 7, wherein the n-well control logic further comprises:
a comparator for comparing the system rail voltage and the LCD drive voltage and generating a level indication of which of the system rail voltage and the LCD drive voltage is higher;
n-well voltage selection control logic responsive to the level indication for generating a system rail voltage selection signal indicating whether to select the system rail voltage and for generating an LCD voltage selection signal indicating whether to select the LCD voltage; and
wherein the system rail selection voltage selection signal and the LCD voltage selection signal are always at different logic levels.

10. The output pad control logic of claim 9, wherein the n-well voltage selection logic further comprises control logic connected to receive the level indication and an LCD indication to indicate whether an LCD mode of operation for the output pad is enabled, the control logic generating the system rail voltage selection signal at a first logical level and the LCD voltage selection signal at a second logical level when either the system rail voltage exceeds the LCD drive voltage or when the LCD indication indicates the LCD mode of operation of the output pad is disabled, the control logic generating the system rail voltage selection signal at the second logical level and the LCD voltage selection signal at the first logical level when either the LCD drive voltage exceeds the system rail voltage or when the LCD indication indicates the LCD mode of operation of the output pad is enabled.

11. A method for controlling a voltage applied to n-wells of transistors of pad control logic, comprising the steps of:
driving an output pad through a plurality of transistors each of the plurality of transistors including an n-well;
connecting a first voltage to the n-wells of the plurality of transistors in a first mode of operation when a system rail voltage exceeds a pad voltage applied to the output pad;
connecting the pad voltage to the n-wells of the plurality of transistors in a second mode of operation when the pad voltage applied to the output pad exceeds the system rail voltage;
connecting the system rail voltage as the first voltage when the output pad is not driving an LCD display; and
connecting a larger of the system rail voltage and an LCD drive voltage as the first voltage when the output pad is driving the LCD display.

12. The method of claim 11, wherein the step of connecting a larger of the system rail voltage and the LCD drive voltage, further comprises the steps of:
selecting either the system rail voltage or the LCD drive voltage as a larger voltage responsive to the at least one control signal; and
selecting the system rail voltage responsive to an indication that the output pad is not driving the LCD display and for selecting the larger voltage responsive to an indication that the output pad is driving the LCD display.

13. The method of claim 11 further including the step of generating the at least one control signal to connect the larger of the system rail voltage and the LCD drive voltage responsive to a determination of a higher of the system rail voltage and the LCD drive voltage.

14. The method of claim 13, wherein the step of generating further comprises the steps of:
comparing the system rail voltage and the LCD drive voltage;
generating a level indication of which of the system rail voltage and the LCD drive voltage is higher;
generating a system rail voltage selection signal indicating whether to select the system rail voltage and generating and LCD voltage selection signal indicating whether to select the LCD voltage responsive to the level indication, wherein the system rail selection voltage selection signal and the LCD voltage selection signal are always at different logic levels.

15. The method of claim 14, wherein the step of generating the system rail voltage selection signal and generating the LCD voltage selection signal further comprises the steps of:
generating the system rail voltage selection signal at a first logical level and the LCD voltage selection signal at a second logical level when either the system rail voltage exceeds the LCD drive voltage or when the LCD indication indicates the LCD mode of operation of the output pad is disabled; and
generating the system rail voltage selection signal at the second logical level and the LCD voltage selection signal at the first logical level when either the LCD drive voltage exceeds the system rail voltage or when the LCD indication indicates the LCD mode of operation of the output pad is enabled.
